(19) United States
(12) Patent Application Publication
(10) Pub. No.: US 2019/0308595 A1
(43) Pub. Date: Oct. 10, 2019

(54) HYDRAULIC PRESSURE CONTROL UNIT FOR VEHICLE BRAKE SYSTEM AND VEHICLE BRAKE SYSTEM

(71) Applicant: Robert Bosch GmbH, Stuttgart (DE)

(72) Inventors: Shogo Miyoshi, Kanagawa (JP); Yoshiro Akada, Kanagawa (JP)

(21) Appl. No.: 16/468,719

(22) PCT Filed: Nov. 14, 2017
(86) PCT No.: PCT/IB2017/057095

§ 371 Date: Jun. 12, 2019

(30) Foreign Application Priority Data
Dec. 12, 2016 (JP) 2016-240063

(51) Int. Cl. B60T 8/48; B60T 8/44

(52) U.S. Cl. CPC B60T 8/4872; B60T 8/442

(57) ABSTRACT

A hydraulic pressure control unit and a vehicle brake system including the hydraulic pressure control unit are obtained. The hydraulic pressure control unit can downsize the brake system in comparison with a conventional brake system.

A hydraulic pressure control unit (50) is a hydraulic pressure control unit for a brake system (1) of a vehicle (100). The hydraulic pressure control unit (50) includes a pump (34) and an accumulator (33) in a secondary channel (14), the pump (34) increasing a hydraulic pressure of brake fluid; and the accumulator (33) storing the brake fluid. The secondary channel (14) is configured to allow a flow of the brake fluid that flows into the accumulator (33) from a suction side of the pump (34).

### BACKGROUND OF THE INVENTION

The invention relates to a hydraulic pressure control unit for a vehicle brake system and a vehicle brake system including the hydraulic pressure control unit, the hydraulic pressure control unit having: a pump that increases a hydraulic pressure of brake fluid; and an accumulator that stores the brake fluid.

As a conventional vehicle brake system that has been available, a vehicle brake system includes a hydraulic circuit having: a primary channel that communicates between a master cylinder and a wheel cylinder; a secondary channel to which brake fluid in the primary channel is released; and a supply channel through which the brake fluid is supplied to an intermediate portion of the secondary channel (for example, see JP-A-2013-249055).

For example, an upstream end of the secondary channel is connected to a region on the wheel cylinder side in the primary channel with an inlet valve being a reference. A downstream end of the secondary channel is connected to a region on the master cylinder side in the primary channel with the inlet valve being the reference. In addition, an upstream end of the supply channel communicates with the master cylinder. A downstream end of the supply channel is connected to a region on a downstream side in the secondary channel with an outlet valve being a reference, and is also connected to a suction side of a pump that is provided in the region. Furthermore, a first switching valve is provided in the region on the master cylinder side in the primary channel with a connected portion of the primary channel with the downstream end of the secondary channel being a reference. A second switching valve is provided in an intermediate portion of the supply channel.

For example, a hydraulic pressure control unit is configured by including the inlet valve, the outlet valve, the pump, the first switching valve, the second switching valve, a base body in which these components are embedded, and a controller that governs operations of these components. In the hydraulic pressure control unit, a hydraulic pressure in the hydraulic circuit is controlled when the operations of the inlet valve, the outlet valve, the pump, the first switching valve, and the second switching valve are controlled.

For example, when a brake operation is performed in an input section (for example, a brake pedal or the like) of the brake system and the wheel is likely to be locked, the controller performs an ABS control operation to drive the pump in a state where the inlet valve is closed, the outlet valve is opened, the first switching valve is opened, and the second switching valve is closed. In this way, the brake fluid in the wheel cylinder is suctioned by the pump through the outlet valve. Thus, the hydraulic pressure of the brake fluid in the wheel cylinder can be lowered, and locking of the wheel can be prevented.

In this ABS control operation, it takes certain time for the pump to be able to sufficiently suction the brake fluid after activation. In other words, the pump cannot sufficiently suction the brake fluid in the wheel cylinder during this time, that is, the brake fluid cannot sufficiently flow out of the wheel cylinder. Thus, locking of the wheel cannot sufficiently be prevented. For this reason, in the hydraulic pressure control unit for the conventional brake system, an accumulator is provided in a region between a connected portion with the downstream end of the supply channel and the outlet valve in the secondary channel. In other words, the hydraulic pressure control unit for the conventional brake system is provided with the accumulator in the region between the outlet valve and the suction side of the pump in the secondary channel. Due to provision of the accumulator, the brake fluid in the wheel cylinder flows into the accumulator and can temporarily be stored in the accumulator until the pump can sufficiently suction the brake fluid after the activation (that is, after the outlet valve is opened). Thus, locking of the wheel can be prevented in an early stage.

For example, when it becomes necessary to increase the hydraulic pressure of the brake fluid in the wheel cylinder, the controller performs a pressure build-up control operation to drive the pump in a state where the inlet valve is opened, the outlet valve is closed, the first switching valve is closed, and the second switching valve is opened regardless of a state of the brake operation by the input section (for example, the brake pedal or the like) of the brake system.

Because the above-described accumulator is provided on the suction side of the pump, there is a case where some of the brake fluid that is supplied to the suction side of the pump is not suctioned by the pump but flows into the accumulator during this pressure build-up control operation. In such a case, the hydraulic pressure of the brake fluid cannot sufficiently be increased. Thus, the hydraulic pressure control unit for the conventional brake system is provided with a check valve in a region between a connected position with the downstream end of the supply channel and the accumulator in the secondary channel, and the check valve restricts a flow of the brake fluid from the connected position to the accumulator. That is, the hydraulic pressure control unit for the conventional brake system is provided with the check valve that restricts a flow of the brake fluid from the suction side of the pump to the accumulator in a region between the accumulator and the suction side of the pump in the secondary channel.

In the recent brake system, there is a case where a booster in the above-described conventional brake system is downsized or where the booster is eliminated from the above-described conventional brake system for a purpose of improved installability of the brake system in a vehicle. That is, there is a case where the recent brake system is downsized by downsizing or eliminating the booster.

The booster boosts (amplifies) a force at a time when the input section of the brake system is operated (for example, a depression force of the brake pedal) and transmits the boosted force to the brake fluid in the hydraulic circuit. Accordingly, in the case where the booster is downsized or eliminated, when a user operates the input section of the brake system, the user feels the higher hydraulic pressure of the brake fluid in the hydraulic circuit, which acts on the input section of the brake system, than that in the case where the booster is neither downsized nor eliminated. Thus, operational feeling of the input section of the brake system differs. For example, in the cases where the input section of the brake system is the brake pedal and the booster is downsized or eliminated, the user feels the higher hydraulic pressure of the brake fluid in the hydraulic circuit, which acts on the brake pedal, than that in the case where the booster is neither downsized nor eliminated. Thus, a depression amount of the brake pedal is reduced.

In view of the above, in the case where the booster is downsized or eliminated in the brake system, the hydraulic pressure control unit for the conventional brake system is provided with a damper unit in addition to the above-described configuration. The brake fluid flows into the damper unit when the input section of the brake system is operated. This damper unit is provided in a region on the master cylinder side in the supply channel with the second switching valve being a reference, for example.

### SUMMARY OF THE INVENTION

As described above, the conventional brake system is downsized by downsizing or eliminating the booster as described above. In this way, the installability of the brake system in the vehicle is improved. However, in the case where the booster is downsized or eliminated, the damper unit has to be added as the new configuration to the hydraulic pressure control unit for the conventional brake system in order to maintain the same operational feeling of the input section of the brake system as before. For this reason, the hydraulic pressure control unit for the conventional brake system has such a problem that, even when it is attempted to downsize the brake system by downsizing or eliminating the booster, the brake system cannot sufficiently be downsized due to the damper unit, which is newly added.

The invention has been made with the above-described problem as the background and therefore has a first purpose of obtaining a hydraulic pressure control unit capable of downsizing a brake system in comparison with a conventional brake system. In addition, the invention has a second purpose of obtaining a vehicle brake system that includes the hydraulic pressure control unit.

A hydraulic pressure control unit according to the invention is a hydraulic pressure control unit for a vehicle brake system. The brake system includes a hydraulic circuit having: a primary channel that communicates between a master cylinder and a wheel cylinder; a secondary channel to which brake fluid in the primary channel is released; and a supply channel through which the brake fluid is supplied to a first intermediate portion as an intermediate portion of the secondary channel. A first downstream end as a downstream end of the secondary channel is connected to a second intermediate portion as an intermediate portion of the primary channel. A first upstream end as an upstream end of the supply channel communicates with the master cylinder. The hydraulic pressure control unit includes: an inlet valve provided in a region on the wheel cylinder side in the primary channel with the second intermediate portion being a reference; an outlet valve provided in a region between a second upstream end and the first intermediate portion in the secondary channel, the second upstream end being an upstream end of the secondary channel; a first switching valve provided on the master cylinder side in the primary channel with the second intermediate portion being a reference; a second switching valve provided in the supply channel; a pump provided in a region between the first intermediate portion and the first downstream end in the secondary channel, a suction side thereof communicating with the first intermediate portion, and a discharge side thereof communicating with the first downstream end; an internal channel being a part of the secondary channel and constituting a channel between the first intermediate portion and the outlet valve; and an accumulator provided in the internal channel. The internal channel is configured to allow a flow of the brake fluid that flows into the accumulator from the first intermediate portion.

A vehicle brake system according to the invention includes the above-described hydraulic pressure control unit.

In the hydraulic pressure control unit and the vehicle brake system according to the invention, the brake fluid flows into the accumulator when an input section of the brake system is operated and the second switching valve is opened. That is, instead of the above-described damper unit that has to be conventionally added at the time when a booster is downsized or eliminated, the accumulator that has conventionally been provided can fulfill the same function as the damper unit. Thus, necessity of adding the damper unit can be reduced when the brake system is downsized by downsizing or eliminating the booster. Therefore, the brake system can be downsized in comparison with the conventional brake system.

### BRIEF DESCRIPTION OF THE DRAWINGS

FIG. 1 is a diagram of a system configuration example of a brake system according to an embodiment of the invention.

FIG. 2 is a diagram of another system configuration example of the brake system according to the embodiment of the invention.

### DETAILED DESCRIPTION

A description will hereinafter be made on a hydraulic pressure control unit according to the invention by using the drawings.

Note that the following description will be made on a case where a brake system that includes the hydraulic pressure control unit according to the invention is mounted on a four-wheeled vehicle; however, the brake system that includes the hydraulic pressure control unit according to the invention may be mounted on vehicles other than the four-wheeled vehicle (a motorcycle, a truck, a bus, and the like). A configuration, an operation, and the like, which will be described below, constitute merely one example, and the brake system that includes the hydraulic pressure control unit according to the invention is not limited to a case with such a configuration, such an operation, and the like. In the drawings, the same or similar members or portions will be denoted by the same reference sign or will not be denoted by a reference sign. In addition, a detailed structure will appropriately be depicted in a simplified manner or will not be depicted.

### Embodiment

A description will hereinafter be made on a brake system according to this embodiment.

### <Configuration and Operation of Brake System>

A description will be made on a configuration and an operation of the brake system according to this embodiment.

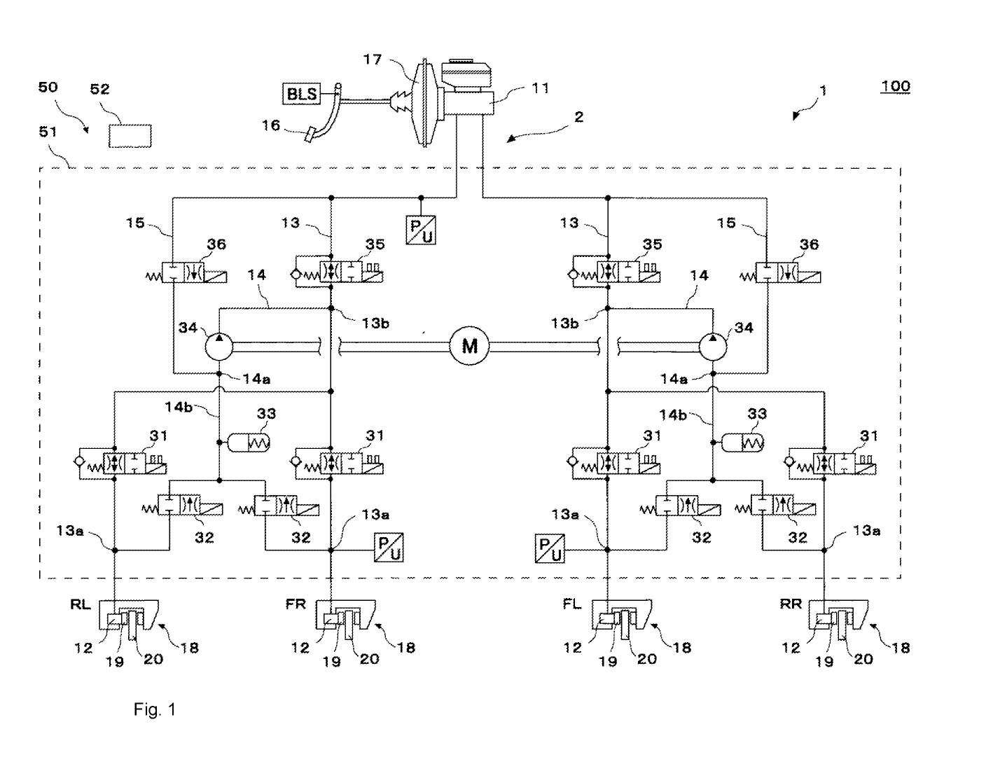

FIG. 1 is a diagram of a system configuration example of the brake system according to the embodiment of the invention.

As depicted in FIG. 1, a brake system 1 is mounted on a vehicle 100 and includes a hydraulic circuit 2. The hydraulic circuit 2 has: primary channels 13, each of which communicates between a master cylinder 11 and wheel cylinders 12; secondary channels 14, to each of which brake fluid in the primary channel 13 is released; and supply channels 15, through each of which the brake fluid is supplied to the secondary channel 14. The hydraulic circuit 2 is filled with the brake fluid.

A piston (not depicted) is installed in the master cylinder 11, and the piston reciprocates in an interlocking manner with a brake pedal 16 as an example of an input section of the brake system 1. A booster 17 is interposed between the brake pedal 16 and the piston in the master cylinder 11, and a depression force by a user is boosted and transmitted to the piston. The wheel cylinder 12 is provided in a brake caliper 18. When a hydraulic pressure of the brake fluid in the wheel cylinder 12 is increased, a brake pad 19 of the brake caliper 18 is pressed against a rotor 20, and a wheel is thereby braked. Note that the booster 17 provided in the brake system 1 according to this embodiment is smaller in size than a booster provided in a conventional brake system in equivalent size to the brake system 1.

An upstream end of the secondary channel 14 is connected to an intermediate portion 13a of the primary channel 13, and a downstream end of the secondary channel 14 is connected to an intermediate portion 13b of the primary channel 13. An upstream end of the supply channel 15 communicates with the master cylinder 11, and a downstream end of the supply channel 15 is connected to an intermediate portion 14a of the secondary channel 14.

The upstream end of the secondary channel 14 corresponds to the second upstream end of the invention. The downstream end of the secondary channel 14 corresponds to the first downstream end of the invention. The intermediate portion 13b of the primary channel 13 corresponds to the second intermediate portion of the invention. The upstream end of the supply channel 15 corresponds to the first upstream end of the invention. The intermediate portion 14a of the secondary channel 14 corresponds to the first intermediate portion of the invention.

An inlet valve (EV) 31 is provided in a region between the intermediate portion 13b and the intermediate portion 13a in the primary channel 13 (a region on the wheel cylinder 12 side with the intermediate portion 13b being a reference). An outlet valve (AV) 32 is provided in a region between the upstream end and the intermediate portion 14a in the secondary channel 14. A pump 34 is provided in a region between the intermediate portion 14a and the downstream end in the secondary channel 14. A suction side of the pump 34 communicates with the intermediate portion 14a, and a discharge side of the pump 34 communicates with the downstream end of the secondary channel 14. The inlet valve 31 is an electromagnetic valve that is opened in an unenergized state and closed in an energized state, for example. The outlet valve 32 is an electromagnetic valve that is closed in the unenergized state and opened in the energized state, for example.

A first switching valve (USV) 35 is provided in a region on the master cylinder 11 side in the primary channel 13 with the intermediate portion 13b being the reference. A second valve (HSV) 36 is provided in the supply channel 15. The first switching valve 35 is an electromagnetic valve that is opened in the unenergized state and closed in the energized state, for example. The second switching valve 36 is an electromagnetic valve that is closed in the unenergized state and opened in the energized state, for example.

An accumulator 33 is provided in a region between the outlet valve 32 and the intermediate portion 14a in the secondary channel 14. In the case where a channel that is a part of the secondary channel 14 and that is located between the intermediate portion 14a and the outlet valve 32 is defined as an internal channel 14b, it can also be said that the accumulator 33 is provided in the internal channel 14b. This internal channel 14b constitutes a part of a configuration of a hydraulic pressure control unit 50. This accumulator 33 fulfills a similar function to an accumulator that is provided in the conventional brake system. That is, during an ABS control operation, the accumulator 33 temporarily stores the brake fluid that has flowed thereinto from the wheel cylinder 12 through the outlet valve 32 until the pump 34 is brought into a state capable of sufficiently suctioning the brake fluid after activation.

The conventional brake system is provided with a check valve in a region on the intermediate portion 14a side in the internal channel 14b for the brake system 1 according to this embodiment with the accumulator 33 being a reference. The check valve restricts a flow of the brake fluid from the intermediate portion 14a to the accumulator 33. On the contrary, the brake system 1 according to this embodiment does not include the check valve provided in the conventional brake system. That is, the brake system 1 according to this embodiment is configured to allow the flow of the brake fluid that flows into the accumulator 33 from the intermediate portion 14a.

The inlet valves 31, the outlet valves 32, the accumulators 33, the pumps 34, the first switching valves 35, and the second switching valves 36 are provided in a base body 51 that is formed with channels constituting the primary channels 13, the secondary channels 14, and the supply channels 15 therein. The members (the inlet valves 31, the outlet valves 32, the accumulators 33, the pumps 34, the first switching valves 35, and the second switching valves 36) may collectively be provided in the single base body 51 or may be divided into the plural base bodies 51.

The hydraulic pressure control unit 50 is configured by at least including the base body 51, the members provided in the base body 51, and a controller (ECU) 52. In the hydraulic pressure control unit 50, when the controller 52 controls operations of the inlet valve 31, the outlet valve 32, the pump 34, the first switching valve 35, and the second switching valve 36, the hydraulic pressure of the brake fluid in each of the wheel cylinders 12 is controlled. The controller 52 performs well-known hydraulic pressure control operations (the ABS control operation, an ESP control operation, and the like), for example.

The controller 52 may be provided as one unit or may be divided into plural units. In addition, the controller 52 may be attached to the base body 51 or may be attached to another member. Furthermore, the controller 52 may partially or entirely be constructed of a microcomputer, a microprocessor unit, or the like, may be constructed of a member in which firmware and the like can be updated, or may be a program module or the like that is executed by a command from a CPU or the like, for example.

In the brake system 1 according to this embodiment, the booster 17 is downsized in comparison with the booster in the conventional brake system. Accordingly, when the brake pedal 16 is depressed, the hydraulic pressure in the hydraulic circuit 2 tends to run short. Thus, in the case where shortage or possible shortage of the hydraulic pressure in the hydraulic circuit 2 is detected from a detection signal of a position sensor for the brake pedal 16 and a detection signal of a hydraulic pressure sensor for the hydraulic circuit 2 when the brake pedal 16 is depressed, the controller 52 initiates an active pressure build-up control operation.

In the active pressure build-up control operation, the controller 52 opens the inlet valve 31, closes the outlet valve 32, closes the first switching valve 35, and opens the second switching valve 36. That is, the controller 52 maintains the opened state of the inlet valve 31 and thereby allows a flow of the brake fluid from the intermediate portion 13b of the primary channel 13 to the wheel cylinder 12. In addition, the controller 52 brings the outlet valve 32 into the closed state and thereby restricts a flow of the brake fluid from the wheel cylinder 12 to the accumulator 33. Furthermore, the controller 52 brings the first switching valve 35 into the closed state and thereby restricts a flow of the brake fluid in a channel between the master cylinder 11 and the intermediate portion 13b of the primary channel 13 without interposing the pump 34 therebetween. Moreover, the controller 52 brings the second switching valve 36 into the opened state and thereby allows a flow of the brake fluid in the channel between the master cylinder 11 and the intermediate portion 13b of the primary channel 13 via the pump 34. Then, the controller 52 drives the pump 34 so as to increase the hydraulic pressure of the brake fluid in the wheel cylinder 12.

During this active pressure build-up control operation, some of the brake fluid that has flowed into the secondary channel 14 from the supply channel 15 through the intermediate portion 14a flows into the accumulator 33 through the internal channel 14b that constitutes the part of the secondary channel 14. Therefore, also during the active pressure build-up control operation, the brake system 1 according to this embodiment can maintain the same depression feeling (operational feeling) of the brake pedal 16 as the conventional feeling.

When it is detected that the shortage of the hydraulic pressure in the hydraulic circuit 2 is resolved or avoided, the controller 52 opens the first switching valve 35, closes the second switching valve 36, and stops driving the pump 34, so as to terminate the active pressure build-up control operation.

Here, the brake pedal 16 is operated (depressed) when it is desired to increase the hydraulic pressure of the brake fluid in the wheel cylinder 12. Thus, the brake pedal 16 is usually operated in the state where the outlet valve 32 is closed. In addition, a state where the outlet valve 32 is opened by the ABS control operation means a state where the hydraulic pressure of the brake fluid on the wheel cylinder 12 side is increased and the hydraulic pressure of the brake fluid in the region on the wheel cylinder 12 side from the outlet valve 32 in the secondary channel 14 is equal to or higher than the hydraulic pressure of the brake fluid in the region on the accumulator 33 side from the outlet valve 32 in the secondary channel 14. Thus, in the hydraulic pressure control unit 50 according to this embodiment, the brake fluid that has flowed from the intermediate portion 14a to the accumulator 33 side is suppressed from further flowing to the wheel cylinder 12 side from the outlet valve 32 and causing a problem.

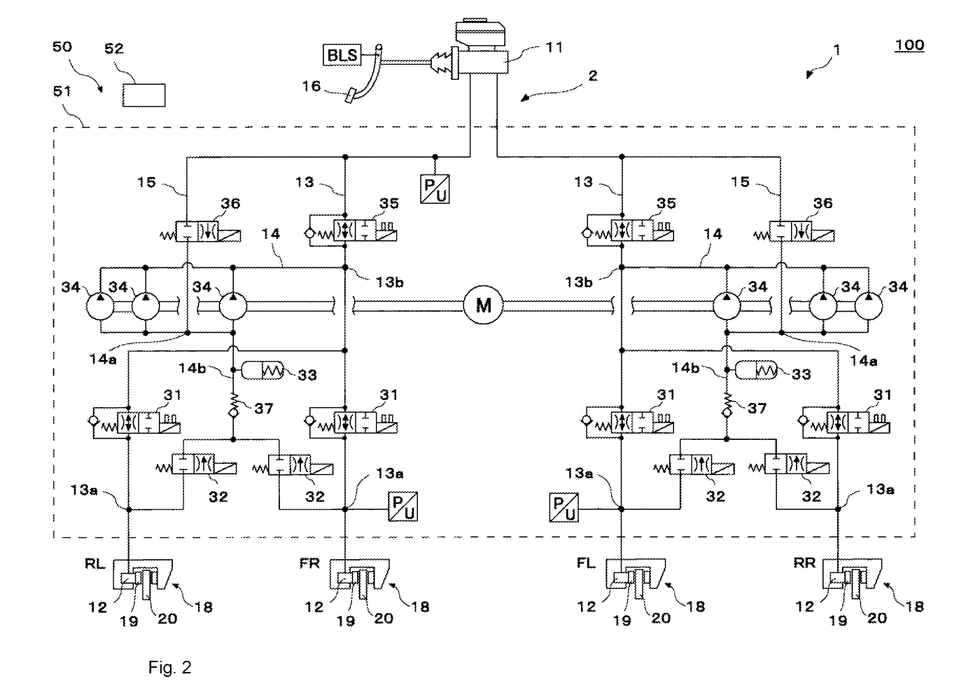

FIG. 2 is a view of another system configuration example of the brake system according to the embodiment of the invention.

The brake system 1 may be the brake system 1 that is depicted in FIG. 2 and from which the booster 17 is eliminated.

That is, the brake system 1 may not have the booster 17 between the brake pedal 16 and the master cylinder 11. In other words, the booster 17 may not be interposed between the brake pedal 16 and the master cylinder 11.

In the case of such a brake system 1 that does not include the booster 17, the depression force of the brake pedal 16 by the user is not boosted by the booster 17 and is directly transmitted to the piston in the master cylinder 11. Accordingly, in the case of such a brake system 1 that does not include the booster 17, when depressing the brake pedal 16, the user feels the even higher hydraulic pressure of the brake fluid in the hydraulic circuit 2, which acts on the brake pedal 16. Thus, a depression amount of the brake pedal 16 is further reduced. For this reason, in the case of such a brake system 1 that does not include the booster 17, it becomes even more important to maintain the same the depression feeling (the operational feeling) of the brake pedal 16 as the conventional feeling. Therefore, in such a brake system 1 that does not include the booster 17, such a configuration that the brake fluid flows into the accumulator 33 at the time when the brake pedal 16 is depressed is further effective.

As depicted in FIG. 2, in the hydraulic pressure control unit 50 of the brake system 1, the plural pumps 34 may be connected in parallel in a region between the intermediate portion 14a and the downstream end in the secondary channel 14. With such a configuration, a discharge amount of the brake fluid from each of the pumps 34 can be reduced. In addition, discharge timing of the brake fluid from each of the pumps 34 can differ. Accordingly, when the plural pumps 34 are provided in a manner to be connected in parallel as in FIG. 2, it is possible to suppress pulsation that is generated by driving of the pumps 34 in the opened state of the second switching valve 36. Needless to say, the brake system 1 that includes the booster 17 depicted in FIG. 1 may be provided with the plural pumps 34 that are connected in parallel as in FIG. 2.

As depicted in FIG. 2, the hydraulic pressure control unit 50 of the brake system 1 may include a check valve 37 in a region on the outlet valve 32 side in the internal channel 14b with the accumulator 33 being a reference, and the check valve 37 restricts a flow of the brake fluid from the accumulator 33 toward the outlet valve 32. In the case where specifications requested for the vehicle 100 is satisfied, such control to open the outlet valve 32 may be required in a state where the hydraulic pressure of the brake fluid in the region on the wheel cylinder 12 side from the outlet valve 32 in the secondary channel 14 is lower than the hydraulic pressure of the brake fluid in the region on the accumulator 33 side from the outlet valve 32 in the secondary channel 14. Due to provision of the check valve 37, even when such control is executed, the brake fluid that has flowed from the intermediate portion 14a to the accumulator 33 side is suppressed from further flowing to the wheel cylinder 12 side from the check valve 37. Therefore, due to the provision of the check valve 37, a degree of freedom in the control of the hydraulic pressure control unit 50, that is, the brake system 1 can be improved. Needless to say, the check valve 37 may be provided as in FIG. 2 in the brake system 1 that includes the booster 17 depicted in FIG. 1.

<Effects of Brake System, that is, Hydraulic Pressure Control Unit>

A description will be made on effects of the brake system 1 according to this embodiment, that is, the hydraulic pressure control unit 50.

The hydraulic pressure control unit 50 according to this embodiment opens the second switching valve 36 when the brake pedal 16 as the input section of the brake system 1 is operated (depressed). In this way, the brake fluid flows into the accumulator 33. That is, in the hydraulic pressure control unit 50 according to this embodiment, instead of the damper unit, the accumulator 33 that has conventionally been provided can fulfill the same function as the damper unit that has to be added to the conventional hydraulic pressure control unit at the time when the booster 17 is downsized or eliminated. Thus, there is no need to add the damper unit, which has conventionally been required, to the hydraulic pressure control unit 50 according to this embodiment when the brake system 1 is downsized by downsizing or eliminating the booster 17. Therefore, the hydraulic pressure control unit 50 according to this embodiment can further downsize the brake system 1 in comparison with the conventional brake system 1.

Note that the hydraulic pressure control unit 50 according to this embodiment preferably includes the check valve 37 in the region on the outlet valve 32 side in the internal channel 14b with the accumulator 33 being the reference, the check valve 37 restricting the flow of the brake fluid from the accumulator 33 toward the outlet valve 32. Due to the provision of the check valve 37, the degree of freedom in the control of the hydraulic pressure control unit 50, that is, the brake system 1 can be improved.

The hydraulic pressure control unit 50 according to this embodiment is preferably used for the brake system 1 in which the booster 17 is not interposed between the brake pedal 16 and the master cylinder 11. In other words, the brake system 1 according to this embodiment preferably does not have the booster 17. It is because such a configuration that the brake fluid flows into the accumulator 33 at the time when the brake pedal 16 is depressed is particularly useful in the brake system 1 that does not include the booster 17.

### REFERENCE SIGNS LIST

1: Brake system
2: Hydraulic circuit
11: Master cylinder
12: Wheel cylinder
13: Primary channel
13a, 13b: Intermediate portion
14: Secondary channel
14a: Intermediate portion
14b: Internal channel
15: Supply channel
16: Brake pedal
17: Booster
18: Brake caliper
19: Brake pad
20: Rotor
31: Inlet valve
32: Outlet valve
33: Accumulator
34: Pump
35: First switching valve
36: Second switching valve
37: Check valve
50: Hydraulic pressure control unit
51: Base body
52: Controller
100: Vehicle

1. A hydraulic pressure control unit for a vehicle brake system,
the brake system including:
a hydraulic circuit having: a primary channel that communicates between a master cylinder and a wheel cylinder; a secondary channel to which brake fluid in the primary channel is released; and a supply channel through which the brake fluid is supplied to a first intermediate portion as an intermediate portion of the secondary channel,
a first downstream end as a downstream end of the secondary channel being connected to a second intermediate portion as an intermediate portion of the primary channel, and
a first upstream end as an upstream end of the supply channel communicating with the master cylinder,
the hydraulic pressure control unit comprising:
an inlet valve provided in a region on a wheel cylinder side in the primary channel with the second intermediate portion being a reference;
an outlet valve provided in a region between a second upstream end and the first intermediate portion in the secondary channel, the second upstream end being an upstream end of said secondary channel;
a first switching valve provided on a master cylinder side in the primary channel with the second intermediate portion being a reference;
a second switching valve provided in the supply channel;
a pump provided in a region between the first intermediate portion and the first downstream end in the secondary channel, a suction side thereof communicating with said first intermediate portion, and a discharge side thereof communicating with said first downstream end;
an internal channel being a part of the secondary channel and providing a channel between the first intermediate portion and the outlet valve; and
an accumulator provided in the internal channel, wherein
the internal channel is configured to allow a flow of the brake fluid that flows into the accumulator from the first intermediate portion.

2. The hydraulic pressure control unit according to claim 1 further comprising:
a check valve in a region on an outlet valve side in the internal channel with the accumulator being a reference, the check valve restricting a flow of the brake fluid from the accumulator toward the outlet valve.

3. The hydraulic pressure control unit according to claim 1
wherein for the brake system in which a booster is not interposed between an input section and the master cylinder.

4. A vehicle brake system comprising:
the hydraulic pressure control unit according to claim 1.

5. A vehicle comprising
a brake system including:
a hydraulic circuit having: a primary channel that communicates between a master cylinder and a wheel cylinder; a secondary channel to which brake fluid in the primary channel is released; and a supply channel through which the brake fluid is supplied to a first intermediate portion as an intermediate portion of the secondary channel,
a first downstream end as a downstream end of the secondary channel being connected to a second intermediate portion as an intermediate portion of the primary channel, and
a first upstream end as an upstream end of the supply channel communicating with the master cylinder, and
a hydraulic pressure control unit comprising:
an inlet valve provided in a region on a wheel cylinder side in the primary channel with the second intermediate portion being a reference;
an outlet valve provided in a region between a second upstream end and the first intermediate portion in the secondary channel, the second upstream end being an upstream end of said secondary channel;
a first switching valve provided on a master cylinder side in the primary channel with the second intermediate portion being a reference;
a second switching valve provided in the supply channel;
a pump provided in a region between the first intermediate portion and the first downstream end in the secondary channel, a suction side thereof communicating with said first intermediate portion, and a discharge side thereof communicating with said first downstream end;
an internal channel being a part of the secondary channel and providing a channel between the first intermediate portion and the outlet valve; and
an accumulator provided in the internal channel, wherein
the internal channel is configured to allow a flow of the brake fluid that flows into the accumulator from the first intermediate portion.

6. The vehicle according to claim 5 further comprising:
a check valve in a region on an outlet valve side in the internal channel with the accumulator being a reference, the check valve restricting a flow of the brake fluid from the accumulator toward the outlet valve.

7. The vehicle according to claim 5
wherein the brake system does not have a booster interposed between an input section and the master cylinder.
